(19) United States
(12) Patent Application Publication
(10) Pub. No.: US 2026/0027586 A1
(43) Pub. Date: Jan. 29, 2026

(54) INTEGRATED MEMS ULTRASONIC TRANSDUCER

(71) Applicant: Huazhong University of Science and Technology, Wuhan City (CN)

(72) Inventors: Bo MA, Wuhan City (CN); Zheng YOU, Wuhan City (CN)

(21) Appl. No.: 19/064,012

(22) Filed: Feb. 26, 2025

(30) Foreign Application Priority Data
Jul. 23, 2024 (CN) 202410994232.7

(51) Int. Cl. B06B 1/02

(52) U.S. Cl. CPC B06B 1/0292

(57) ABSTRACT

Provided is an integrated micro-electromechanical systems (MEMS) ultrasonic transducer (UT). The integrated MEMS UT (MUT) includes a capacitive MUT body, and a piezoelectric structure provided on a resonant plate of the capacitive MUT body. In embodiments of the present disclosure, the piezoelectric structure forms a piezoelectric MUT with the resonant plate and a chamber in the capacitive MUT body, and the piezoelectric MUT and the capacitive MUT body share the resonant plate to obtain the integrated MUT. The embodiments of the present disclosure integrate the advantages of piezoelectric MUT and the capacitive MUT, and achieve the effect of improving the receiving sensitivity while not affecting the resonance amplitude and the output sound pressure.

### CROSS REFERENCE TO RELATED APPLICATION

This patent application claims the benefit and priority of Chinese Patent Application No. 2024109942327, filed with the China National Intellectual Property Administration on Jul. 23, 2024, the disclosure of which is incorporated by reference herein in its entirety as part of the present application.

### TECHNICAL FIELD

The present disclosure relates to the technical field of micro-nano sensing devices, and in particular, to an integrated micro-electromechanical systems (MEMS) ultrasonic transducer (UT).

### BACKGROUND

The MEMS UT (MUT) mainly includes a capacitive (CMUT) and a piezoelectric (PMUT). The CMUT has been widely used in medical imaging diagnosis and treatment, high-intensity focused ultrasound, handheld personal medical ultrasound equipment, chemical sensing, gas medium coupling and other applications due to its significant advantages of broad bandwidth, easy large-scale array manufacturing, and easily integrated with an specific integrated circuit (ASIC). However, the core performance of the conventional CMUT, such as receiving sensitivity, output sound pressure, and driving voltage, are all limited by the chamber height. The smaller the chamber height, the higher the receiving sensitivity and the lower the driving voltage, but the resonance amplitude and the output sound pressure are significantly limited. Increasing the chamber height can increase the output sound pressure, but will result in a significant decrease in receiving sensitivity and a significant increase in driving voltage. In recent years, with the invention of an aluminum nitride (AlN)-based piezoelectric material, PMUT has developed very rapidly because it is compatible with MEMS and IC processes and suitable for mass production, and its output sound pressure is not limited by a gap between plates. However, the existing AlN-based piezoelectric material has a relatively low piezoelectric coefficient, relatively low sensitivity, and a relatively high driving voltage, compared with PZT or other single crystal piezoelectric materials.

### SUMMARY

An objective of the present disclosure is to provide an integrated MUT, which may improve the receiving sensitivity while not affecting the resonance amplitude and the output sound pressure.

To achieve the above objective, the present disclosure provides the following solutions:

The present disclosure provides an integrated MUT. The integrated MUT includes a capacitive MUT body, and a piezoelectric structure provided on a resonant plate of the capacitive MUT body.

Optionally, the piezoelectric structure includes a piezoelectric layer and an electrode layer.

Optionally, there is one or more piezoelectric structures;
when there are a plurality of piezoelectric structures, the plurality of piezoelectric structures are distributed at different positions, and/or, the plurality of piezoelectric structures are in different polarization directions and capable of being integrated to adjust a vibration mode of the resonant plate.

Optionally, the capacitive MUT body is a single-chamber capacitive MUT or a multi-chamber capacitive MUT.

Optionally, the single-chamber capacitive MUT includes a substrate, a chamber provided on the substrate, a resonant plate provided at a top of the chamber, and an insulating layer provided between the resonant plate and the chamber.

Optionally, the multi-chamber capacitive MUT includes a substrate, a plurality of chambers provided on the substrate, and an insulating layer provided between a resonant plate and the chamber, where the resonant plate is at least disposed at a top of each chamber, upper and lower adjacent chambers share a resonant plate, at least two of the plurality of chambers have different heights in a natural state, and/or, at least one of the resonant plates shared by the upper and lower adjacent chambers is capable of deforming.

Optionally, at least one surface of at least one resonant plate is a conformal surface, and/or, an electrode provided on an upper surface of the substrate has a conformal surface, and/or, at least a part of the upper surface of the substrate is a conformal surface.

Optionally, the conformal surface includes a three-dimensional curved surface, multiple steps, a slope, or a combined structure, and the combined structure is a combination of at least one of the three-dimensional curved surface, the multiple steps, and the slope.

Optionally, the substrate is provided with one or more through vias and/or a plate hollow, and/or, a part of the substrate located in the chamber is provided with microfluidic channels.

Optionally, each chamber corresponds to a pair of electrostatic lead electrodes, and the adjacent chambers share a same electrostatic lead electrode; and
the piezoelectric structure corresponds to a pair of piezoelectric lead electrodes.

Optionally, the integrated MUT includes at least one of a normal operating mode and a collapse operating mode, where the normal operating mode and the collapse operating mode both include a single-receiving sub-mode, a single-sending sub-mode, a dual-receiving sub-mode, a dual-sending sub-mode, and a cooperative assistance sub-mode.

Optionally, there is one or more piezoelectric structures;
where when there are a plurality of piezoelectric structures, all or some of the piezoelectric structures cooperate with the capacitive MUT body to enable the integrated MUT to operate in the dual-sending sub-mode, the dual-receiving sub-mode, or the cooperative assistance sub-mode of the normal operating mode or the collapse operating mode.

Optionally, when there are a plurality of piezoelectric structures, some of the piezoelectric structures cooperate with the capacitive MUT body and operate in the cooperative assistance sub-mode of the normal operating mode or the collapse operating mode, and the remaining piezoelectric structures are configured to send or receive signals.

Optionally, when the capacitive MUT body is a single-chamber capacitive MUT:
in the dual-receiving mode, the pair of electrostatic lead electrodes corresponding to the chamber in the capacitive MUT body is connected to a direct-current electrostatic bias voltage, and the chamber in the capacitive MUT body and/or the piezoelectric structure are configured to receive signals;
in the dual-sending mode, the pair of piezoelectric lead electrodes of the piezoelectric structure is connected to a piezoelectric driving signal, and the pair of electrostatic lead electrodes corresponding to the chamber in the capacitive MUT body is connected to an electrostatic driving signal; and
in the cooperative assistance mode, when a signal is received, the pair of piezoelectric lead electrodes of the piezoelectric structure is connected to a first direct-current piezoelectric bias voltage such that a height of the chamber in the capacitive MUT body decreases, and the chamber in the capacitive MUT body is configured to receive a signal; and when a signal is sent, the pair of piezoelectric lead electrodes of the piezoelectric structure is connected to a second direct-current piezoelectric bias voltage such that the height of the chamber in the capacitive MUT body increases, and the pair of electrostatic lead electrodes corresponding to the chamber in the capacitive MUT body is connected to an electrostatic driving signal.

Optionally, when the capacitive MUT body is a single-chamber capacitive MUT:
in the dual-receiving mode, a receiving chamber in the capacitive MUT body and the piezoelectric structure are both configured to receive signals, and the receiving chamber is one or more chambers in the capacitive MUT body;
in the dual-sending mode, a sending chamber in the capacitive MUT body and the piezoelectric structure are both configured to send signals, and the sending chamber is one or more chambers in the capacitive MUT body; and
in the cooperative assistance mode, the piezoelectric structure is configured to change a height of a main chamber in the capacitive MUT body, the main chamber is configured to send or receive a signal, and the main chamber is one or more chambers adjacent to the piezoelectric structure in the capacitive MUT body.

Optionally, in the dual-sending mode, an auxiliary chamber in the capacitive MUT body is capable of increasing the height of the sending chamber in the capacitive MUT body, and the auxiliary chamber is a chamber adjacent to the sending chamber in the capacitive MUT body.

Optionally, in a collapse mode, the chamber in the capacitive MUT body is in a collapse state,
where
the pair of piezoelectric lead electrodes of the piezoelectric structure is connected to a direct-current piezoelectric bias voltage, such that the chamber in the capacitive MUT body is in the collapse state, and
when the chamber in the collapse state serves as a receiving chamber, the pair of electrostatic lead electrodes corresponding to the chamber in the collapse state is connected to a direct-current electrostatic bias voltage, and the chamber in the collapse state is configured to receive a signal; and
when the chamber in the collapse state serves as a sending chamber, the pair of electrostatic lead electrodes corresponding to the chamber in the collapse state is connected to an electrostatic driving signal, and the electrostatic driving signal is an alternating-current driving signal, or a signal obtained after the alternating-current driving signal is subjected to direct-current bias, or a continuous pulse signal, or a signal obtained after the continuous pulse signal is subjected to direct-current bias.

Optionally, in a collapse mode, the chamber in the capacitive MUT body is in a collapse state,
where
the pair of electrostatic lead electrodes corresponding to the chamber in the capacitive MUT body is connected to a direct-current electrostatic bias voltage, such that the chamber in the capacitive MUT body is in the collapse state, and
when the chamber in the collapse state serves as a receiving chamber, the chamber in the collapse state is configured to receive a signal, and/or, the piezoelectric structure is configured to receive a signal; and
when the chamber in the collapse state serves as a sending chamber, the pair of piezoelectric lead electrodes of the piezoelectric structure is connected to a piezoelectric driving signal, and/or, the pair of electrostatic lead electrodes corresponding to the chamber in the collapse state is connected to an electrostatic driving signal.

Optionally, the piezoelectric driving signal is an alternating-current driving signal; and
the electrostatic driving signal is an alternating-current driving signal, or a signal obtained after the alternating-current driving signal is subjected to direct-current bias, or a continuous pulse signal, or a signal obtained after the continuous pulse signal is subjected to direct-current bias.

According to specific embodiments provided in the present disclosure, the present disclosure has the following technical effects:

An integrated MUT is provided. The integrated MUT includes a capacitive MUT body, and a piezoelectric structure provided on a resonant plate of the capacitive MUT body. In the embodiments of the present disclosure, the piezoelectric structure forms a piezoelectric MUT with the resonant plate in the capacitive MUT body, and the piezoelectric MUT and the capacitive MUT body share the resonant plate to obtain the integrated MUT. The embodiments of the present disclosure integrate the advantages of piezoelectric MUT and the capacitive MUT, and achieve the effect of improving the receiving sensitivity while not affecting the resonance amplitude and the output sound pressure.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can still be derived from these accompanying drawings by those of ordinary skill in the art without creative efforts.

FIG. 1 is a schematic structural diagram of an existing CMUT according to embodiments of the present disclosure;

FIG. 2 is a schematic structural diagram of an existing PMUT according to embodiments of the present disclosure;

FIG. 3 is a schematic structural diagram of an integrated MUT according to embodiments of the present disclosure;

FIGS. 4A-4B are schematic diagrams of a multi-electrode configuration of an integrated MUT according to embodiments of present disclosure;

FIGS. 5A-5D are schematic diagrams of dual-receiving, dual-sending, negative piezoelectric bias and positive piezoelectric bias electrode configurations of an integrated MUT according to embodiments of present disclosure;

FIGS. 6A-6B are schematic diagrams of a plurality of position-optimizable piezoelectric layers and various polarization polarity structures of an integrated MUT according to embodiments of present disclosure;

FIGS. 7A-7D are schematic structural diagrams of an integrated MUT having a conformal electrode according to embodiments of the present disclosure;

FIGS. 8A-8D are schematic structural diagrams of an integrated MUT including a through via, and microfluidic structures according to embodiments of the present disclosure;

FIGS. 9A-9E are schematic diagrams of structure and electrode configurations of an integrated MUT operating in a collapse mode according to embodiments of present disclosure;

FIGS. 10A-10B are schematic diagrams of structure and electrode configurations of an integrated MUT which includes a conformal electrode and microfluidic structures and operates in a collapse mode according to embodiments of present disclosure;

FIG. 11 is a schematic diagram of an integrated MUT including multiple plates and multiple chambers according to embodiments of the present disclosure;

FIGS. 12A-12C are schematic diagrams of an electrode configuration of an integrated MUT including multiple plates and multiple chambers according to embodiments of present disclosure;

FIGS. 13A-13B are schematic diagrams of an electrode configuration of an integrated MUT including multiple plates, multiple chambers, and a conformal electrode according to embodiments of present disclosure;

FIGS. 14A-14C are schematic structural diagrams of an integrated MUT including multiple plates, multiple chambers, hollow plate and microfluidic structure according to embodiments of the present disclosure;

FIGS. 15A-15B are comparison diagrams of sending and receiving sensitivity of a CMUT and a PMUT according to embodiments of the present disclosure;

FIGS. 16A-16B are schematic diagrams of capacitance under a negative piezoelectric bias electrode configuration and air gap change and receiving sensitivity change of an integrated MUT according to embodiments of the present disclosure;

FIGS. 17A-17B are schematic diagrams of capacitance under a positive piezoelectric bias electrode configuration and air gap change and output sound pressure change of an integrated MUT according to embodiments of the present disclosure;

FIG. 18 is a schematic diagram of a receiving sensitivity effect under piezoelectric and electrostatic dual-receiving electrode configurations according to embodiments of the present disclosure;

FIG. 19 is a schematic diagram of an output sound pressure effect under piezoelectric and electrostatic dual-sending electrode configurations according to embodiments of the present disclosure; and

FIG. 20 is a schematic diagram of a sending sound pressure sensitivity change after position optimization of a piezoelectric layer of an integrated MUT according to embodiments of the present disclosure.

### DETAILED DESCRIPTION OF THE EMBODIMENTS

The technical solutions in the embodiments of the present disclosure are described clearly and completely below with reference to the accompanying drawings in the embodiments of the present disclosure. Apparently, the described embodiments are merely some rather than all of the embodiments of the present disclosure. All other embodiments obtained by those skilled in the art based on the embodiments of the present disclosure without creative efforts shall fall within the protection scope of the present disclosure.

An objective of the present disclosure is to provide an integrated MUT, which may improve the receiving sensitivity while not affecting the resonance amplitude and the output sound pressure.

To make the above-mentioned objective, features, and advantages of the present disclosure clearer and more comprehensible, the present disclosure will be further described in detail below in conjunction with the accompanying drawings and specific embodiments.

The embodiments of the present disclosure provide an integrated MUT. The integrated MUT includes a capacitive MUT body, and a piezoelectric structure provided on a resonant plate of the capacitive MUT body.

According to the embodiments of the present disclosure, piezoelectric sensing is integrated with a CMUT to form a new form of MUT, i.e., an integrated MUT, remarkably improving the receiving sensitivity and receiving bandwidth of an MUT, and significantly increasing the output sound pressure and reducing the driving voltage. The proposed integrated MUT has a piezoelectric structure, and the piezoelectric structure forms a PMUT with the resonant plate of the capacitive MUT body, which can receive and send an ultrasonic signal. Piezoelectricity and static electricity can synchronously operate in a dual-receiving mode, and accumulatively receive signals to remarkably improve the receiving sensitivity; or, the piezoelectricity and the static electricity synchronously operate in a dual-sending mode, and implement push-pull combined driving to significantly reduce the driving voltage and increase the output sound pressure; or, the static electricity operates in a primary role, and the piezoelectricity operates in a secondary role: by applying a negative piezoelectric bias, the CMUT operates at a position exceeding a Pull-in effect, thereby reducing the air gap of the CMUT and remarkably improving the receiving sensitivity; or, by applying a positive piezoelectric bias, the air gap of the CMUT is increased, and the output sound pressure is remarkably increased. The size, shape and position of the piezoelectric structure can also be optimized, such that multi-level modes of the resonant plate are integrated, and the bandwidth is remarkably widened. The proposed integrated MUT can operate in a normal mode and a collapse mode.

The structure of the invented integrated MUT is described in details below by taking single-chamber and dual-chamber integrated MUTs as examples.

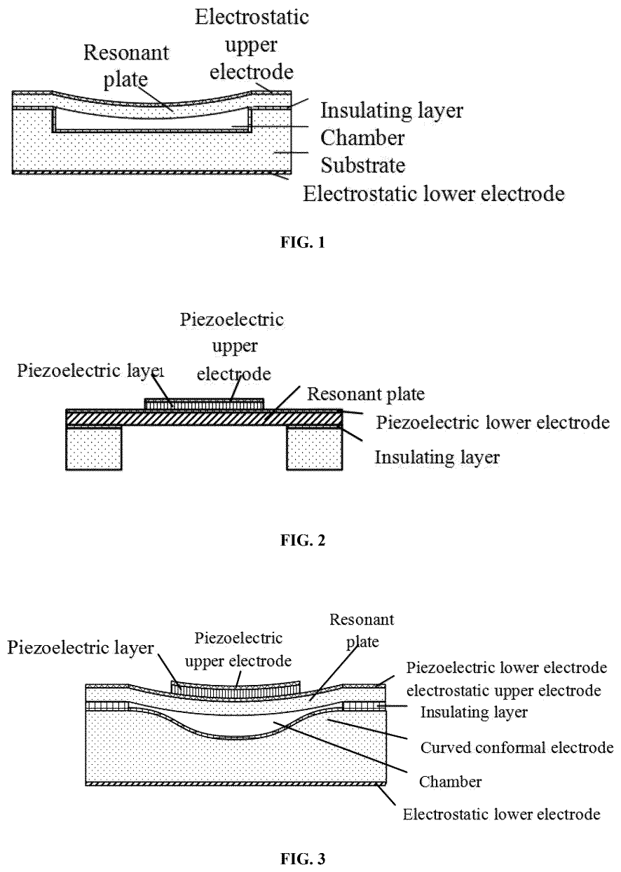

The conventional CMUT mainly consists of a resonant plate and a chamber, as shown in FIG. 1. The chamber is generally in vacuum (an external air pressure causing the plate to deform). The core performance of the conventional CMUT, such as sensitivity, output sound pressure, and driving voltage, is significantly limited by the height of the chamber. The higher the chamber, the greater the output sound pressure, but will result in lower sensitivity and higher driving voltage, and vice versa. In the CMUT, the driving voltage consists of a bias voltage (Vdc) and an alternating-current voltage (Vac). The bias voltage is generally a percentage voltage, i.e., the percentage of the maximum voltage that can be applied, namely a pull-in voltage (Vpi). The pull-in voltage is directly proportional to the 1.5th power of the height of the chamber. The sending sensitivity and the receiving sensitivity are both inversely proportional to the square of the height of the chamber.

The conventional PMUT consists of a resonant plate and a deposited piezoelectric layer, as shown in FIG. 2. In theory, the PMUT is not limited by the height of the chamber, and there is no upper limit of the output sound pressure. However, the current piezoelectric material AlN or AlScN available for a MEMS process has a relatively low piezoelectric coefficient, resulting in relatively low sensitivity and a relatively high driving voltage.

Therefore, to integrate the advantages of the CMUT and PMUT and eliminate the disadvantages of the two, the integrated MUT claimed in the present disclosure is provided. As shown in FIG. 3, the integrated MUT includes, for example, a substrate, a chamber, an insulating layer, a resonant plate, and a piezoelectric layer. The substrate, the chamber, the insulating layer, and the resonant plate are constituent parts of the CMUT (i.e., the above capacitive MUT body). The piezoelectric layer is disposed on the resonant plate of the CMUT. The piezoelectric layer and the resonant plate constitute a PMUT, which can receive and send ultrasonic signals.

The piezoelectric structure corresponds to a pair of piezoelectric lead electrodes. Each chamber in the CMUT corresponds to a pair of electrostatic lead electrodes. When the CMUT includes a plurality of chambers, the adjacent chambers may share a same electrostatic lead electrode.

In one example, the piezoelectric layer and the CMUT may share an lead electrode. Taking FIG. 3 as an example, the top and the bottom of the piezoelectric layer are each provided with a piezoelectric lead electrode: a piezoelectric upper electrode and a piezoelectric lower electrode/electrostatic upper top in FIG. 3. The CMUT in FIG. 3 has a chamber, the electrostatic electrode at the top of the chamber and the bottom of the piezoelectric layer share an electrode, which is also the piezoelectric lower electrode/electrostatic upper electrode in FIG. 3. The electrostatic electrode at the substrate serves as the other electrostatic lead electrode of the chamber, i.e., the electrostatic lower electrode in FIG. 3.

Of course, the piezoelectric layer and the CMUT may also not share an lead electrode, for example, in the following case:
the resonant plate is divided into two layers: a resonant plate and a conductive layer, where the resonant plate is prepared from a non-conductive material and can vibrate but is insulated, and the conductive layer can serve as an lead electrode on the lower surface of the resonant plate. The lead electrode of the piezoelectric layer can be placed on the upper surface of the resonant plate, and in this case, the piezoelectric layer and the CMUT do not share an lead electrode.

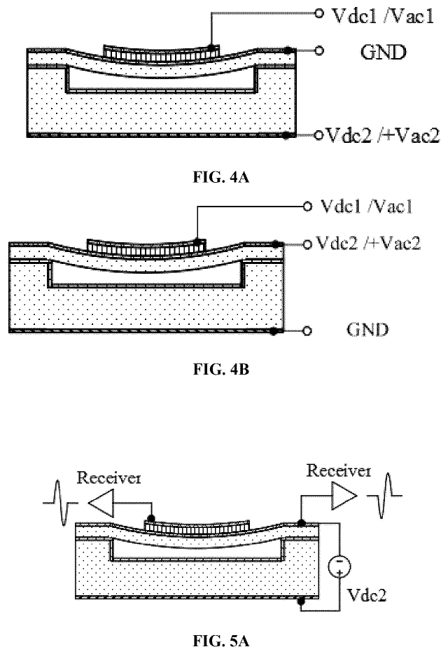

Furthermore, as shown in FIGS. 4A-4B, during circuit connection, the piezoelectric layer and one chamber of the CMUT may be connected in parallel or in series.

To implement parallel connection, the lead electrode shared by the piezoelectric layer and the chamber of the CMUT is designed to be connected to the ground (GND), and GND serves as a common negative electrode. The other lead electrode may be connected to a positive electrode of a signal connected to the piezoelectric layer/chamber.

For example, as shown in FIG. 4A, the piezoelectric upper electrode may be connected to a positive electrode of a first signal (Vdc1/Vac1), the electrostatic lower electrode may be connected to a positive electrode of a second signal (Vdc2/+Vac2), the piezoelectric lower electrode/electrostatic upper electrode may be connected to GND, and at this time, the piezoelectric layer and one chamber of the CMUT may be connected in parallel.

To implement series connection, the lead electrode located at the bottommost part or the topmost part can be designed to be connected to GND, and as a common negative electrode, the other lead electrode is connected to the positive electrode of the signal connected to the piezoelectric layer/chamber.

For example, as shown in FIG. 4B, the piezoelectric upper electrode may be connected to the positive electrode of the first signal (Vdc1/Vac1), the piezoelectric lower electrode/electrostatic upper electrode may be connected to the positive electrode of the second signal (Vdc2/+Vac2), the electrostatic lower electrode may be connected to GND, and at this time, the piezoelectric layer and one chamber of the CMUT may be connected in series.

It should be noted that “Vdc1/Vac1” in FIGS. 4A-4B represents Vdc1 or Vac1 application, and “Vdc2/+Vac2” represents Vdc2 or Vac2 application or Vdc2 and Vac2 application (“+” represents application, but does not represent “positive” in “positive and negative”).

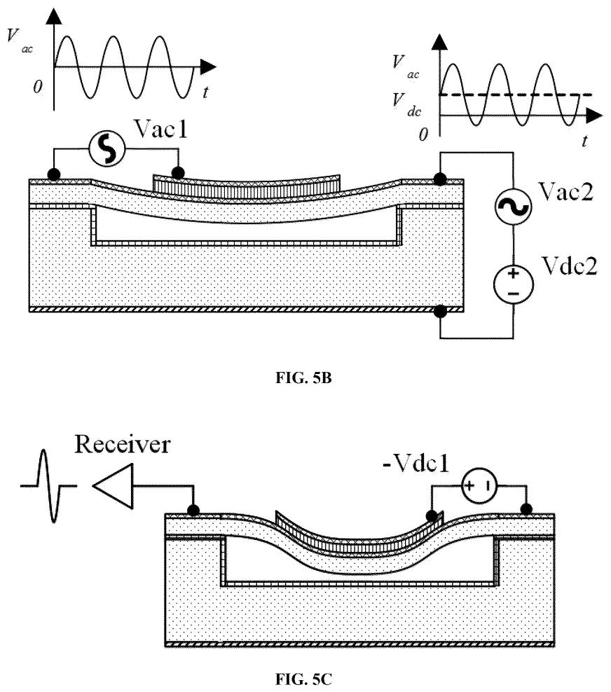

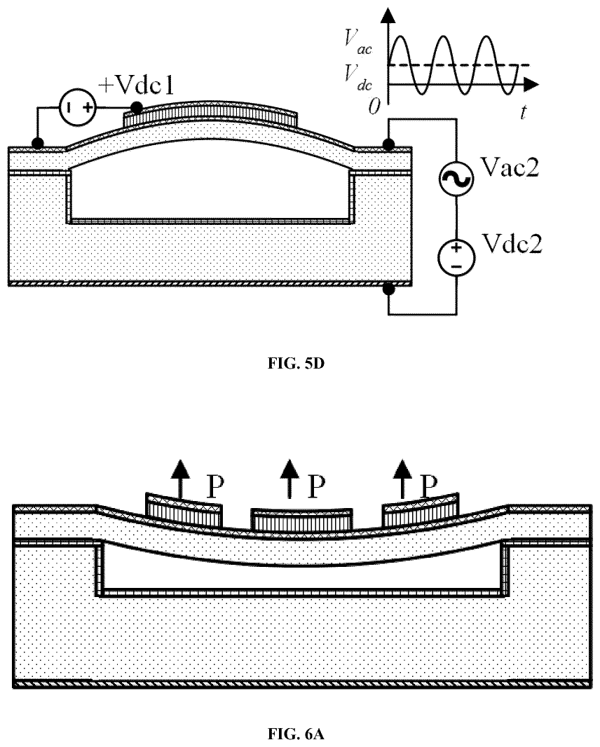

In one aspect, the integrated MUT may have a plurality of electrode configurations, as shown in FIGS. 4A-4B and FIGS. 5A-5D. The piezoelectricity and the static electricity can synchronously operate in the dual-receiving mode, as shown in FIG. 5A, and accumulatively receive signals to improve the receiving sensitivity; or, the piezoelectricity and the static electricity operate in the dual-sending mode, as shown in FIG. 5B, and implement push-pull combined driving to remarkably reduce the driving voltage and increase the output sound pressure.

Or, the static electricity operates in a primary role, and the piezoelectricity operates in a secondary role: by applying a negative piezoelectric bias (note: when the polarization direction of the piezoelectric layer is upward, the negative piezoelectric bias can be applied, and when the direction is downward, the positive piezoelectric bias needs to be applied to make the piezoelectric layer deform downwards), the CMUT can operate at the position exceeding the Pull-in effect, as shown in FIG. 5C, thereby reducing the air gap of the CMUT and significantly improving the receiving sensitivity; by applying the positive piezoelectric bias, the air gap of the CMUT can be increased, as shown in FIG. 5D (note: when the polarization direction of the piezoelectric layer is upward, the positive piezoelectric bias can be applied, and when the direction is downward, the negative piezoelectric bias needs to be applied to make the piezoelectric layer deform upwards), and the output sound pressure can be remarkably increased. The piezoelectricity or the static electricity may also serve as a detection means to feed back the resonance amplitude or position information, thereby achieving accurate closed-loop resonance control.

The plurality of electrode configurations in the present disclosure include, but are not limited to the typical configuration shown in FIGS. 5A-5D.

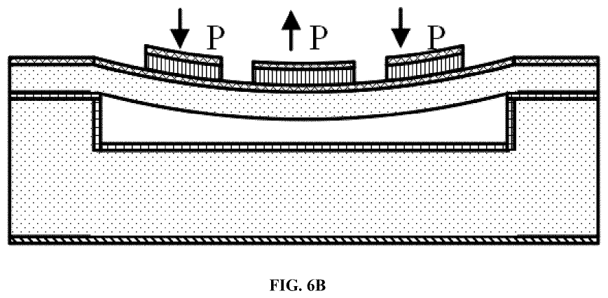

On one aspect, the size, shape, position, quantity, polarization direction and the like of the piezoelectric layer can be flexibly configured by those skilled in the art. For example, FIGS. 6A-6B shows a structure having three piezoelectric layers. The vibration directions of different regions of the resonant plate can be controlled through different polarization directions, such that a plurality of vibration modes are integrated, and the bandwidth is prominently widened. In FIGS. 6A-6B, when the P (polar) arrow is upward, the polarization direction of the piezoelectric layer is upward; and when the P (polar) arrow is downward, the polarization direction of the piezoelectric layer is downward. The piezoelectric material needs to be polarized at high temperature or high pressure to make the lattice direction of a piezoelectric crystal consistent, to achieve the best piezoelectric effect. Different polarization directions also require corresponding different applied voltage polarities. If the polarization direction is downward, a positive voltage needs to be applied to deform downward, or otherwise, a negative voltage needs to be applied. Therefore, when there are different polarization directions, and the voltage in the same direction is applied, the deformation direction is opposite, such that the modes can be integrated.

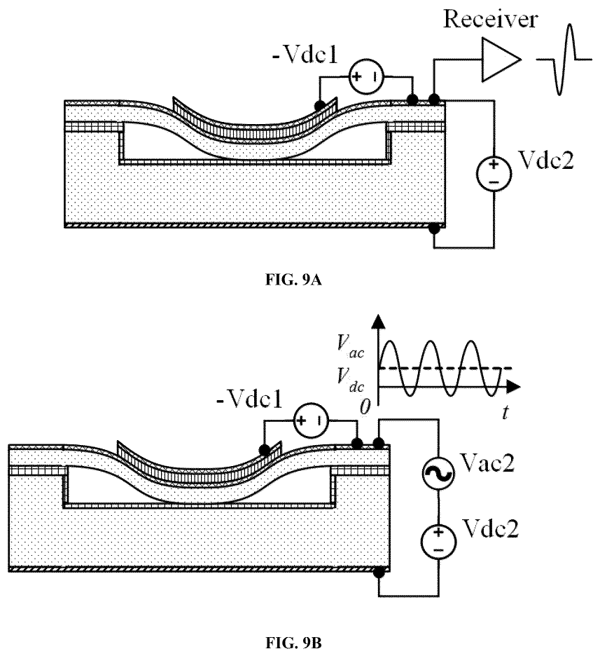

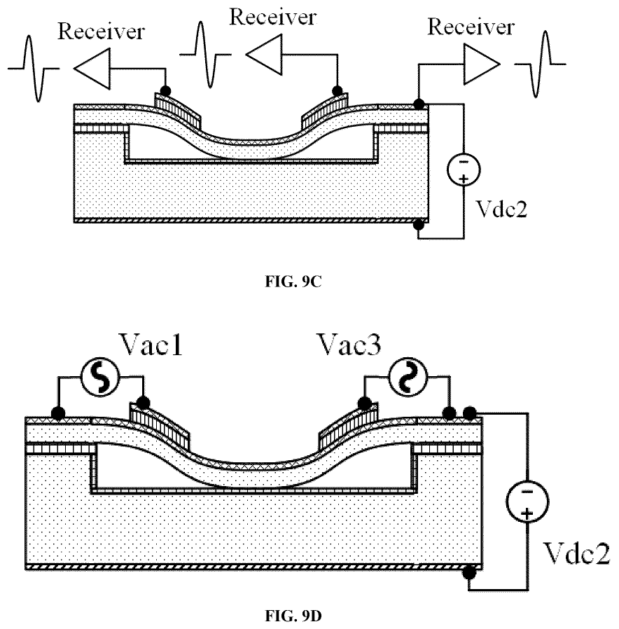

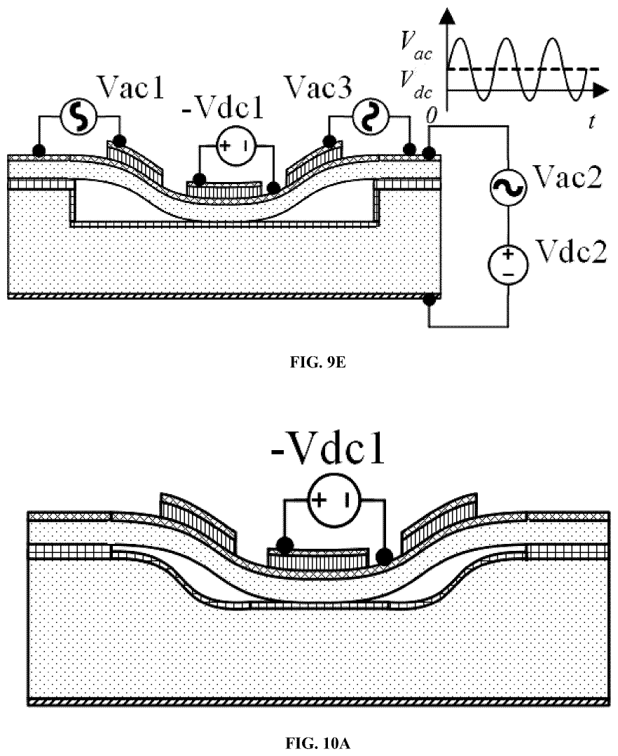

A plurality of piezoelectric layers can share a piezoelectric lead electrode, as shown in FIG. 9B and FIG. 9C, there is one piezoelectric lead electrode at the bottom of the plurality of piezoelectric layers. Of course, a plurality of piezoelectric layers may not share a piezoelectric lead electrode, which will not be repeated herein.

The shape of the piezoelectric layer in the present disclosure includes, but is not limited to, a circle, an ellipse, a ring, a square, a rectangle, a round shape, or a polygon such as a pentagon, a hexagon, and an octagon; and the size and position thereof include, but are not limited to, the typical size and position shown in FIGS. 6A-6B.

The material of the piezoelectric layer in the embodiments of the present disclosure is not limited to aluminum nitride (AlN), and also includes, but is not limited to, scandium-doped aluminum nitride (AlScN), zinc oxide (ZnO), lead zirconate titanate (PZT) piezoelectric ceramic, composite PZT, polyvinylidene fluoride (PVDF), lithium niobate (LiNbO₃), barium titanate (BaTiO₃), cadmium sulfide (CdS), quartz, etc.

The material of the resonant plate in the embodiments of the present disclosure is not limited to single crystal silicon (Si), also includes, but is not limited to, polycrystalline silicon (Poly), silicon nitride (SixNy), silicon oxide (SiO₂), diamond, etc., also includes, but is not limited to, gold (Au), silver (Ag), aluminum (Al), copper (Cu), tungsten (W), molybdenum (Mo), nickel (Ni), palladium (Pd), platinum (Pt), titanium (Ti), cobalt (Co), chromium (Cr), germanium (Ge), indium (In), tantalum (Ta), iridium (Ir), ruthenium (Ru) and other metals, and includes, but is not limited to, brass, bronze, tin-brass, phosphor-bronze, aluminum-bronze, silicon-bronze, silicon-red brass, copper-nickel, nickel-silver, nickel-molybdenum, nickel-chromium, nickel-chromium-iron, nickel-chromium-molybdenum, nickel-chromium-cobalt, nickel-titanium, gold-copper, gold-silver, gold-platinum, gold-zinc, gold-palladium, gold-nickel, gold-cadmium, platinum-iridium, platinum-cobalt, platinum-palladium, platinum-ruthenium, platinum-rhodium, platinum-tungsten, platinum-copper, aluminum-copper, aluminum-manganese, aluminum-magnesium, aluminum-magnesium-silicon, aluminum-zinc, aluminum-tin, titanium-copper, titanium-aluminum, titanium-nickel, titanium-molybdenum, titanium-palladium, tungsten-rhenium, iridium-rhenium, and other metal alloys.

The material of the electrodes (piezoelectric electrode and electrostatic electrode) in the embodiments of the present disclosure is not limited to aluminum (Al), also includes, but is not limited to, metal silver (Ag), gold (Au), cobalt (Co), chromium (Cr), copper (Cu), germanium (Ge), indium (In), molybdenum (Mo), nickel (Ni), palladium (Pd), platinum (Pt), silicon (Si), titanium (Ti), tantalum (Ta), tungsten (W) and combinations of the above metals, etc., and includes, but is not limited to, highly doped single crystal silicon (Si), highly doped polycrystalline silicon (Poly), etc.

The material of the insulating layer in the embodiments of the present disclosure is not limited to silicon oxide (SiO₂), and also includes, but is not limited to, silicon nitride (Si₃N₄), aluminum oxide (Al₂O₃), aluminum nitride (AlN), hafnium oxide (HfO₂), zirconium oxide (ZrO₂), tantalum oxide (Ta₂O₅), etc.

The material of the substrate in the embodiments of the present disclosure is not limited to silicon (Si), and also includes, but is not limited to, germanium (Ge), gallium arsenide (GaAs), glass, quartz, sapphire, etc.

The chamber in the embodiments of the present disclosure is not limited to be in vacuum, also includes, but is not limited to be filled with air, helium (He), argon (Ar) and a combined gas thereof, etc., and includes, is not limited to, a high-dielectric-constant gas such as nitrogen (N₂), sulfur hexafluoride (SF₆), and ammonia (NH₃).

In other embodiments of the present disclosure, the integrated MUT in all the above embodiments can also be additionally designed with a 3D conformal electrode, to remarkably improve the sensitivity, increase the receiving bandwidth and the sending sound pressure, and reduce the driving voltage.

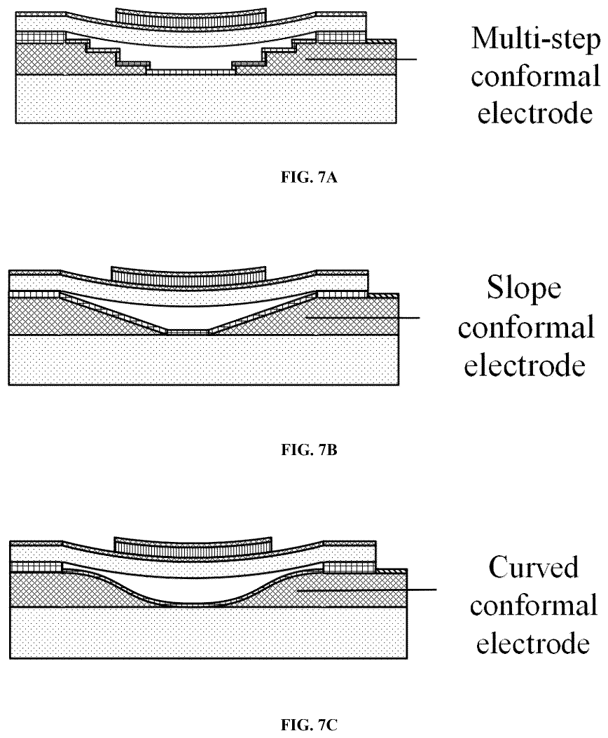

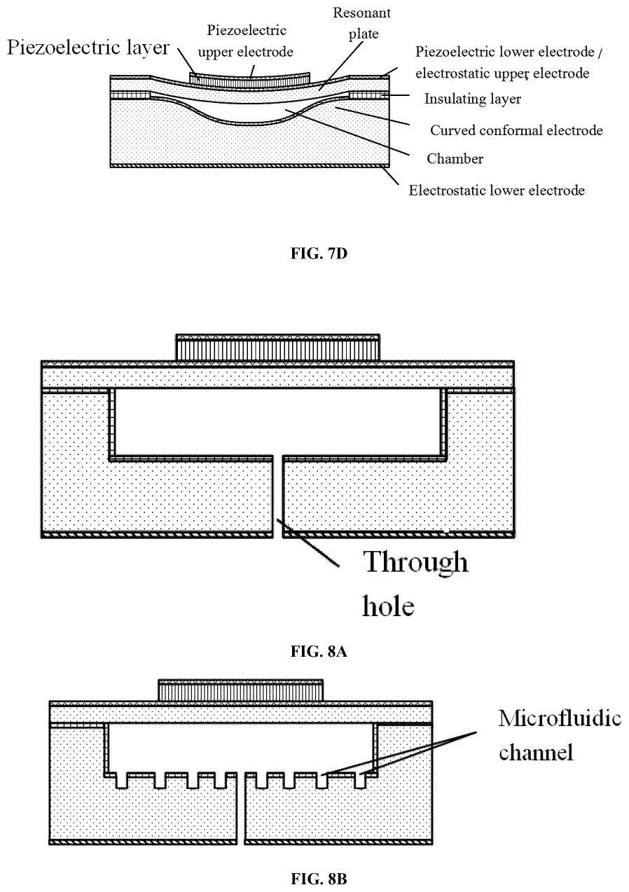

The 3D conformal electrode includes, but is not limited to, a 3D structure such as multiple steps (as shown in FIG. 7A), a slope (as shown in FIG. 7B), a curved surface (as shown in FIG. 7C), and a multi-section slope (not shown in FIGS. 7A-7D). If the substrate or the resonant plate in the embodiments of the present disclosure is made of a conductive material, the substrate or the resonant plate can be integrated with the conformal electrode, i.e., a conformal substrate shown in FIG. 7D.

Compared with the conventional planar electrode, the 3D conformal electrode can reduce the equivalent physical air gap between the electrodes by having the same structural shape as the deformed resonant plate, thereby significantly improving sensitivity and reducing the driving voltage while not affecting the maximum resonance amplitude and output sound pressure. Compared with the conventional planar electrode, the electrostatic sensitivity can be further increased by 70% or above, and the electrostatic driving voltage can be reduced by 80% or above.

It should be noted that the structure of the 3D conformal electrode includes, but is not limited to, the typical structure shown in FIGS. 7A-7D. For example, the structure of the 3D conformal electrode includes, but is not limited to, multiple combined structures of a 3D conformal curved surface, multiple steps, and a slope, or a multi-section combined structure. The design of the 3D conformal electrode in the present disclosure includes, but is not limited to, being used for the substrate and the resonant plate alone, and also includes, but is not limited to, being used for the substrate and the resonant plate in combination.

The material of the 3D conformal electrode in the present disclosure is not limited to single crystal silicon (Si), also includes, but is not limited to, polycrystalline silicon (Poly), germanium (Ge), gallium arsenide (GaAs), glass, quartz, sapphire, diamond, etc., includes, but is not limited to, an insulating material such as silicon oxide (SiO₂), silicon nitride (Si₃N₄), aluminum oxide (Al₂O₃), aluminum nitride (AlN), hafnium oxide (HfO₂), zirconium oxide (ZrO₂), tantalum oxide (Ta₂O₅), etc., and includes, but is not limited to, metal aluminum (Al), silver (Ag), gold (Au), cobalt (Co), chromium (Cr), copper (Cu), germanium (Ge), indium (In), molybdenum (Mo), nickel (Ni), palladium (Pd), platinum (Pt), silicon (Si), titanium (Ti), tantalum (Ta), tungsten (W) and combinations and alloys of the above metals.

The integrated MUT of the present disclosure includes, but is not limited to, the typical structures shown in FIG. 3 and FIGS. 7A-7D.

It should be noted that since the materials used for the various components of the integrated MUT have been described above, for the sake of convenience, in the accompanying drawings corresponding to the subsequent embodiments, the resonant plate and the substrate are made of the same material. Those skilled in the art can understand that different components may also be made of different materials.

On another aspect, the bandwidth of the integrated MUT and the dynamic response characteristics of the resonant plate can be adjusted by introducing gas squeeze-film damping. The bandwidth of the CMUT is directly proportional to the damping of a propagation medium. The propagation mechanism of the conventional CMUT has small damping. Therefore, to increase the bandwidth, in the embodiments of the present disclosure, the gas squeeze-film damping can be introduced to increase the damping term to increase the bandwidth of the transducer.

Since the height of the chamber is usually as low as the micrometer to nanometer level, the gas squeeze-film effect will dominate the dynamic characteristics (response frequency, response time, etc.) of the resonant plate. The gas squeeze-film effect includes a stiffening effect and a damping effect, where the stiffening effect prominently increases the resonance frequency of the resonant plate, and the damping effect prominently affects the dynamic response (response frequency and response time) of the system, and can be configured to adjust the bandwidth.

Specifically, the gas squeeze-film damping tuning microstructure may include any one or any combination of a through via, microfluidic channels, and hollowed plate, which are introduced in sequence below.

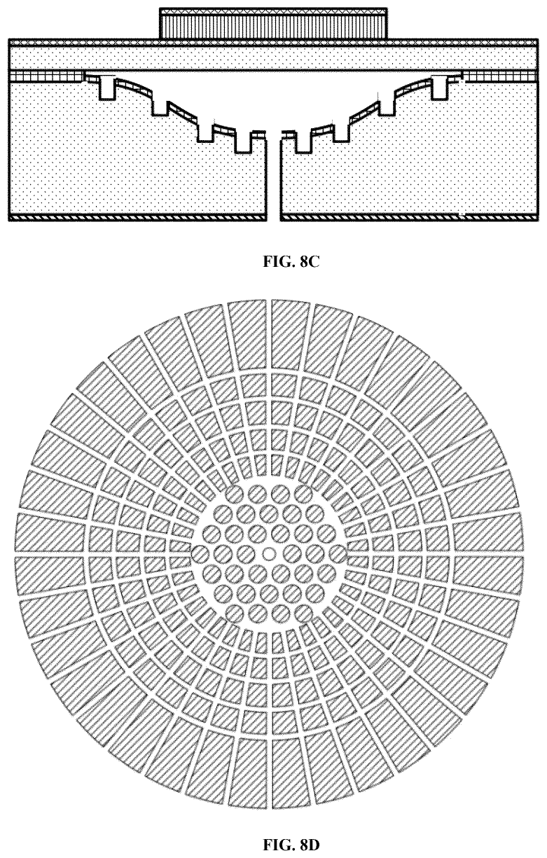

As shown in FIG. 8A, a gas can be introduced into the chamber through a tiny through via in the substrate. The size of the through via may be in the micrometer level or below. For example, the diameter of the through via ranges from 1 μm to 500 μm, and particularly preferably from 10 μm to 50 μm.

Those skilled in the art can flexibly design the size, quantity and distribution of the through via according to actual requirements, which will not be repeated herein.

In other embodiments of the present disclosure, as shown in FIG. 8B and FIG. 8C, the surface of the substrate in all the above embodiments facing the resonant plate may employ microfluidic channels (i.e., microfluidic channels being provided on the surface), to adjust the dynamic characteristics of the resonant plate, prominently increase the bandwidth, and remarkably reduce the driving voltage of the secondary chamber. The mentioned microfluidic channels design has a variety of structures and layouts, such as a micro-pillar array, fan-shaped channels, and a hybrid microfluidic structure of the micro-pillar array and the fan-shaped channels. The typical structure is as shown in FIG. 8D. FIG. 8D includes protrusions of different shapes (a columnar protrusion and a fan-shaped protrusion), and microfluidic channels are between the adjacent protrusions. By adjusting the height/depth of the microfluidic channels, the bandwidth can be adjusted.

In other embodiments of the present disclosure, at least one resonant plate in all the above embodiments may be of a hollowed structure, and the gas squeeze-film effect may also be introduced. As shown in FIG. 14C, the integrated MUT includes a plurality of chambers, and the resonant plate shared by the chambers is of a hollowed structure.

Of course, the resonant plate may also be provided with a through via to introduce the gas squeeze-film effect. The size of the through via may refer to the above descriptions, which will not be repeated herein.

The through via, the hollow, and the microfluidic channels mentioned above can be used in any combination, which will not be repeated herein.

Furthermore, the through via, the hollowed plate, and the microfluidic channels mentioned above are also applicable to the integrated MUT having a 3D conformal electrode, as shown in FIG. 8C, which will not be repeated herein.

The structure of the microfluidic channels and the structure of the chamber in the present disclosure include, but are not limited to, the typical structures shown in FIGS. 8A-8D.

The microfluidic structure in the present disclosure includes, but is not limited to, a micro-pillar array, fan-shaped channels, and a hybrid microfluidic structure of the micro-pillar array and the fan-shaped channels, which can be uniformly or non-uniformly distributed.

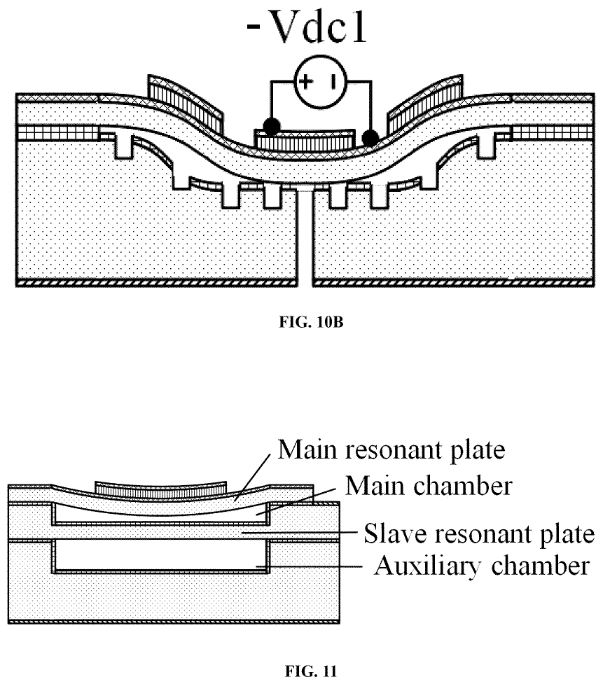

On another aspect, the proposed integrated MUT may also operate in a collapse mode. As shown in FIGS. 9A-9E and FIGS. 10A-10B, FIG. 9A, FIG. 9B, and FIG. 9E are schematic diagrams, in which a pair of piezoelectric lead electrodes of the piezoelectric structure is connected to a direct-current piezoelectric bias voltage (−Vdc1), such that a single-piezoelectric-layer integrated MUT operates in the collapse mode; FIG. 9C and FIG. 9D are schematic diagrams, in which a pair of electrostatic lead electrodes of the chamber is connected to a direct-current electrostatic bias voltage (Vdc2), such that the single-piezoelectric-layer integrated MUT operates in the collapse mode; and FIG. 10A and FIG. 10B are schematic diagrams, in which the integrated MUT including three piezoelectric layers and a 3D conformal electrode operates in the collapse mode. As shown in FIGS. 9A-9E and FIGS. 10A-10B, by applying a direct-current piezoelectric bias voltage or a direct-current electrostatic bias voltage greater than the pull-in voltage, the resonant plate collapses towards the substrate. Since the air gap between the collapsed plate and the substrate electrode is very small, the electric field strength is very high, resulting in high sensitivity. Also, the electrostatic electrode can be designed with a 3D conformal curved surface, and the substrate electrode can also be designed with a microsome structure to adjust the basic dynamic response characteristics and bandwidth of the resonance.

The structure of the integrated MUT of the present disclosure in the collapse mode includes, but is not limited to, the typical structures shown in FIGS. 9A-9E and FIGS. 10A-10B.

As shown in FIG. 9A, the pair of piezoelectric lead electrodes of the piezoelectric structure is connected to the direct-current piezoelectric bias voltage (−Vdc1), such that the chamber of the capacitive MUT body is in the collapse state, and the pair of electrostatic lead electrodes corresponding to the chamber in the collapse state is connected to the direct-current piezoelectric bias voltage (Vdc2). At this time, the chamber in the collapse state serves as a receiving chamber, and the integrated MUT is configured to receive a signal.

As shown in FIG. 9B, the pair of piezoelectric lead electrodes of the piezoelectric structure is connected to the direct-current piezoelectric bias voltage (−Vdc1), such that the chamber of the capacitive MUT body is in the collapse state, and the pair of electrostatic lead electrodes corresponding to the chamber in the collapse state is connected to an electrostatic driving signal (Vac2 and Vdc2 are being connected in series). At this time, the chamber in the collapse state serves as a sending chamber, and the integrated MUT is configured to send a signal.

The following configurations may also be made in some cases: the pair of electrostatic lead electrodes corresponding to the chamber in the capacitive MUT body is connected to a direct-current electrostatic bias voltage, such that the chamber in the capacitive MUT body is in a collapse state; and the chamber in the collapse state is configured to receive a signal, and/or, the piezoelectric structure is configured to receive a signal.

For example, as shown in FIG. 9C, the pair of electrostatic lead electrodes corresponding to the chamber in the capacitive MUT body is connected to the direct-current electrostatic bias voltage (Vdc2), such that the chamber in the capacitive MUT body is in the collapse state, and the pair of piezoelectric lead electrodes of the piezoelectric structure and the pair of electrostatic lead electrodes corresponding to the chamber in the collapse state are configured to receive signals. At this time, the chamber in the collapse state serves as a receiving chamber, and the integrated MUT is configured to receive a signal.

The following configurations may also be made in some cases: the pair of electrostatic lead electrodes corresponding to the chamber in the capacitive MUT body is connected to the direct-current electrostatic bias voltage, such that the chamber in the capacitive MUT body is in a collapse state; and the pair of piezoelectric lead electrodes of the piezoelectric structure is connected to a piezoelectric driving signal, and/or, the pair of electrostatic lead electrodes corresponding to the chamber in the collapse state is connected to an electrostatic driving signal (at this time, the chamber in the collapse state serves as a sending chamber, and the integrated MUT is configured to send a signal).

For example, as shown in FIG. 9D, the pair of electrostatic lead electrodes corresponding to the chamber in the capacitive MUT body is connected to the direct-current electrostatic bias voltage (Vdc2), such that the chamber in the capacitive MUT body is in the collapse state, and the pair of piezoelectric lead electrodes of the piezoelectric structure is connected to the piezoelectric driving signal (Vac1 and Vac2). At this time, the piezoelectric structure is configured to receive a signal.

It should be noted that the integrated MUT having a plurality of piezoelectric structures is similar to the integrated MUT having one piezoelectric structure in terms of electrode configuration. For the integrated MUT having a plurality of piezoelectric structures, how to connect the piezoelectric lead electrodes of each piezoelectric structure may refer to the electrode configurations of FIGS. 4A-4B and FIGS. 5A-5D, which will not be repeated herein.

In addition, it should be noted that in the case of a plurality of piezoelectric layers, the piezoelectric structure may have different effects due to different connecting signals. Taking FIG. 9E as an example, two piezoelectric structures among three piezoelectric structures are connected to alternating-current signals (Vac1 and Vac3), and the piezoelectric structure in the middle is connected to the direct-current piezoelectric bias voltage (−Vdc1). The piezoelectric structure in the middle achieves a bias effect, the resonant plate collapses towards the substrate, and the two piezoelectric structures at the periphery are configured to send signals. FIG. 9E shows that the piezoelectricity and the static electricity synchronously send signals, and the performance difference from independent transmission may refer to FIG. 19. In addition, if the use is receiving, the piezoelectric structure in the middle may still serve as the bias, and the piezoelectric structures at the periphery may serve as receivers; moreover, the direct-current electrostatic bias voltage can be applied to the CMUT body, and the CMUT body and peripheral piezoelectric layers synchronously receive signals.

On another aspect, the integrated MUT may have a multi-plate and multi-chamber structure. As shown in FIG. 11, a piezoelectric layer is disposed on a main resonant plate.

The integrated MUT having multiple plates and multiple chambers may have a plurality of electrode configuration modes as follows.

In a dual-receiving mode, the pair of electrostatic lead electrodes corresponding to a receiving chamber in the capacitive MUT body is connected to a direct-current electrostatic bias voltage, such that the height of the receiving chamber in the capacitive MUT body decreases, the receiving chamber in the capacitive MUT body and/or the piezoelectric structure are configured to receive signals, and the receiving chamber is one or more chambers in the capacitive MUT body.

In a dual-sending mode, the pair of electrostatic lead electrodes corresponding to an auxiliary chamber in the capacitive MUT body is connected to a direct-current electrostatic bias voltage, such that the height of a sending chamber in the capacitive MUT body increases, the pair of electrostatic lead electrodes corresponding to the sending chamber in the capacitive MUT body is connected to an electrostatic driving voltage and/or the pair of piezoelectric lead electrodes of the piezoelectric structure is connected to a piezoelectric driving voltage, the auxiliary chamber is adjacent to the sending chamber, and the sending chamber is one or more chambers in the capacitive MUT body.

In a cooperative assistance mode, when a signal is received, the pair of piezoelectric lead electrodes of the piezoelectric structure is connected to a direct-current piezoelectric bias voltage, such that the height of the receiving chamber in the capacitive MUT body decreases, and the receiving chamber in the capacitive MUT body is configured to receive a signal.

In a cooperative assistance mode, when a signal is sent, the pair of piezoelectric lead electrodes of the piezoelectric structure is connected to a second direct-current piezoelectric bias voltage, such that the height of the sending chamber in the capacitive MUT body increases, and the pair of electrostatic lead electrodes corresponding to the sending chamber in the capacitive MUT body is connected to an electrostatic driving signal.

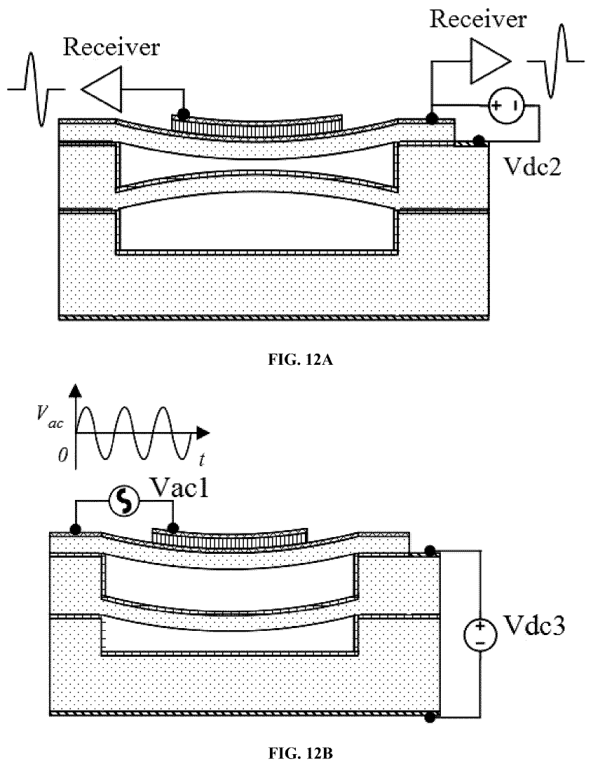

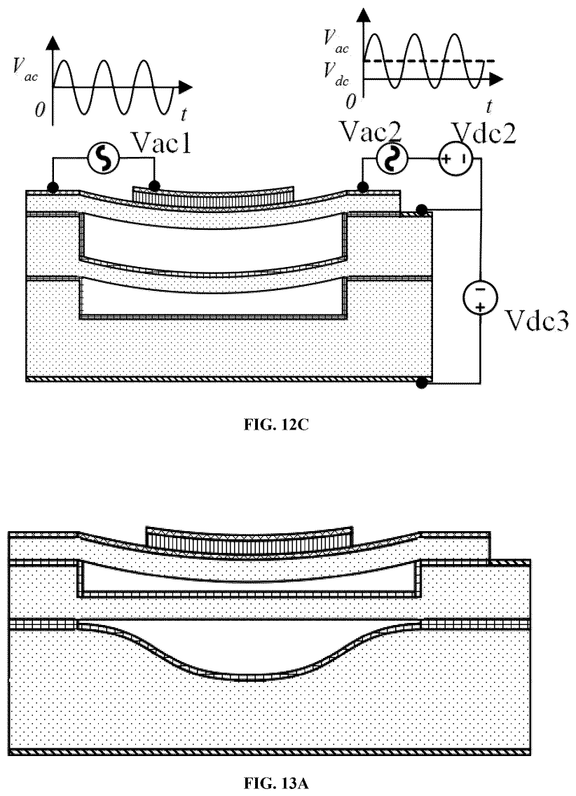

For example, as shown in FIGS. 12A-12C, the electrode configuration mode is not limited to several modes given in the drawings. For example, the direct-current electrostatic bias voltage is applied to the receiving chamber in the capacitive MUT body to adjust the height of the air gap of the receiving chamber. The receiving chamber, when for receiving, has a small air gap to improve the sensitivity, and the piezoelectric structure may also for receiving, as shown in FIG. 12A. The direct-current electrostatic bias voltage is applied to the auxiliary chamber in the capacitive MUT body to adjust the height of the air gap of the sending chamber. The sending chamber has a large air gap to increase the output sound pressure. The piezoelectric structure is for sending, as shown in FIG. 12B. The direct-current electrostatic bias voltage is applied to the auxiliary chamber to adjust the height of the air gap of the sending chamber. The piezoelectric structure is for sending. The piezoelectric structure and the main chamber may also be synchronously for sending, as shown in FIG. 12C. For example, the main chamber (a chamber located at the upper part in FIGS. 12A-12C) is a chamber adjacent to the piezoelectric structure, and is a chamber mainly for sending or receiving a signal; and the auxiliary chamber (a chamber located at the lower part in FIGS. 12A-12C) is a chamber adjacent to the main chamber, and is a chamber capable of adjusting the height of the main chamber. A slave resonant plate is provided between the auxiliary chamber and the main chamber.

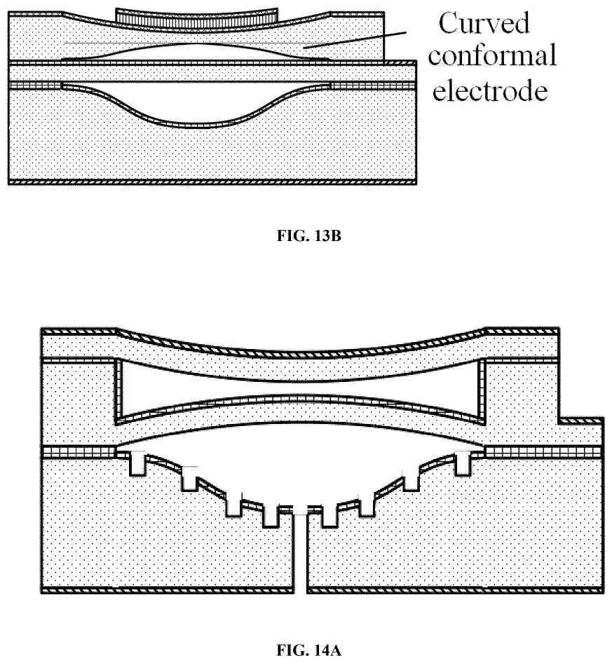

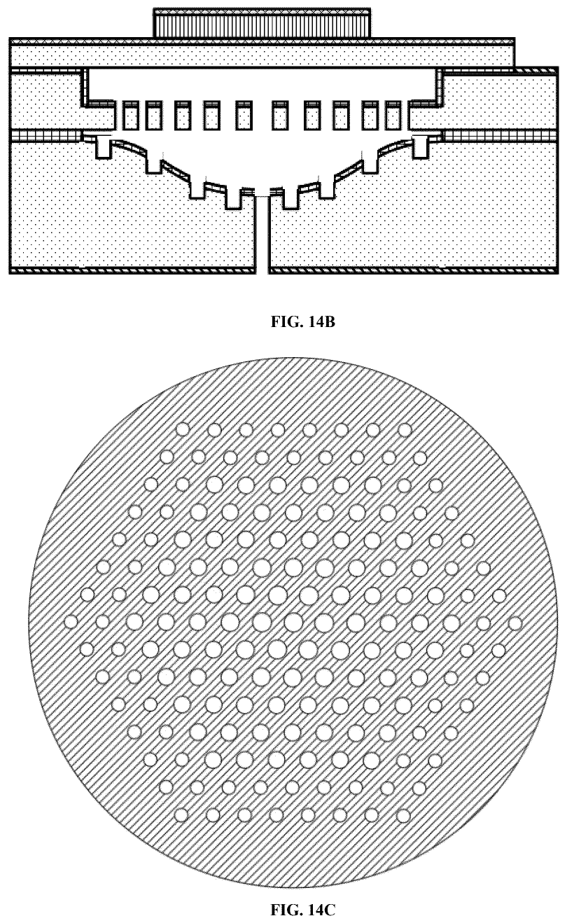

Also, multiple chambers and multiple plates may also use a 3D conformal electrode structure to prominently improve the sensitivity and prominently reduce the driving voltage, as shown in FIG. 13A and FIG. 13B.

In FIG. 13A, the surface of the substrate facing the auxiliary chamber is a 3D conformal surface. In FIG. 13B, the surface of the main resonant plate (a resonant plate at the upper part of the main chamber) facing the main chamber is a 3D conformal surface (in FIG. 13B, a curved conformal electrode representing the position of the 3D conformal surface), and the surface of the substrate facing the auxiliary chamber is a 3D conformal surface. In addition, it should be noted that the resonant plate and the substrate in FIGS. 13A-13B are, for example, made of the same material, such as silicon. Those skilled in the art can flexibly select the material of each component, which will not be repeated herein.

The 3D conformal surface shown in FIGS. 13A-13B is a curved surface. It can be understood that the 3D conformal surface may also be of other structures. The structure of the 3D conformal surface may refer to the above descriptions, which will not be repeated herein.

Also, the slave resonant plate may also use a 3D conformal electrode design. In some structures, the slave resonant plate is connected to the main chamber and the auxiliary chamber, and two surfaces of the slave resonant plate are both set as conformal surfaces. In addition, in other structures, the slave resonant plate is possibly connected to only one chamber, then the surface of the slave resonant plate facing the chamber is set as a conformal surface.

In some scenes, an insulating layer may be laid on the slave resonant plate, and the surface of the insulating layer located in the chamber may be designed as a 3D conformal surface.

The conformal surface of the slave resonant plate can be designed according to its own maximum deformation, which will not be repeated herein.

In addition to the exemplified structure shown in FIG. 11, the main resonant plate and the slave resonant plate may also use a 3D conformal electrode design, or, the slave resonant plate and the substrate both use 3D conformal electrodes, or, the main resonant plate, the slave resonant plate, and the substrate all use 3D conformal electrodes.

Also, the gas squeeze-film damping effect may also be introduced in the integrated MUT having multiple plates and multiple chambers to adjust the dynamic response of the MUT and increase the bandwidth.

For example, a tiny through via may be formed in the substrate to introduce a gas into the chamber, as shown in FIG. 14A and FIG. 14B.

For another example, microfluidic channels may be provided on the surface of the substrate facing the resonant plate, as shown in FIG. 14A and FIG. 14B.

For another example, a through via and/or a hollowed plate (as shown in FIG. 14B) may be formed in the resonant plate between the adjacent chambers to introduce the gas squeeze-film damping effect. The typical hollowed structure is as shown in FIG. 14C.

In FIG. 14B, for the CMUT, the upper chamber is the main chamber, and the lower chamber is the auxiliary chamber. Taking reception as an example, an ultrasonic signal directly hits a non-hollowed resonant plate through a hollowed resonant plate, and the non-hollowed resonant plate receives the ultrasonic signal. At this time, since the substrate is also provided with a through via, the two chambers can simultaneously receive the ultrasonic signal through the non-hollowed resonant plate, thereby amplifying a current generated by the reception. When sending, ultrasonic waves are mainly sent by the non-hollowed resonant plate and the main chamber.

For example, the size of the through via formed in the resonant plate or the substrate may be in the micrometer level or below. For example, the diameter of the through via ranges from 1 μm to 500 μm, and particularly preferably from 10 μm to 50 μm. Those skilled in the art can flexibly design the size, quantity and distribution of the through via according to actual requirements, which will not be repeated herein.

After the gas squeeze-film effect is introduced, the dynamic characteristics of the uppermost resonant plate can be adjusted, and the bandwidth is prominently increased.

The structure of the integrated MUT having multiple resonant plates and multiple chambers of the present disclosure includes, but is not limited to, the typical structures shown in FIG. 11 to FIGS. 14A-14C.

The following is an introduction to the performance of the integrated MUT in a normal mode, with specific parameters:

The operating frequency of the integrated MUT is set as 1.0 MHz. The CMUT is of a single-chamber structure, and a single piezoelectric layer is placed above the resonant plate. To reduce geometric nonlinearity, a resonant plate having a thickness of 20 μm is selected. The piezoelectric material is AlN compatible with the MEMS technology, with a thickness of 1 μm and covering approximately ⅔ of the radius of the resonant plate.

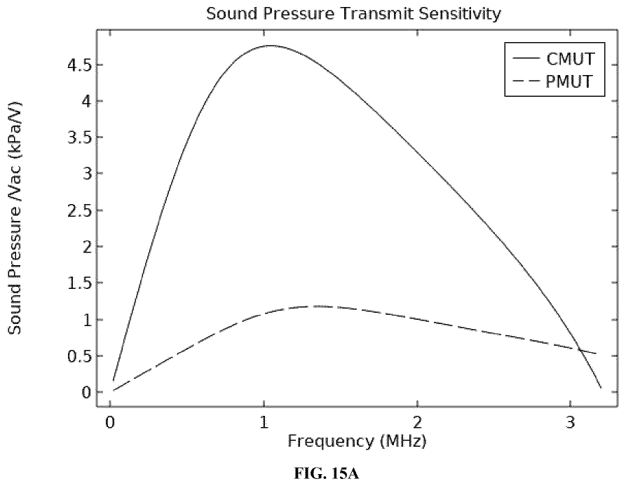

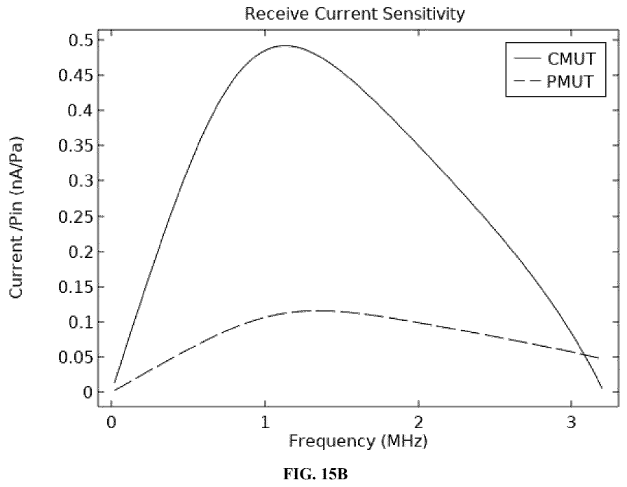

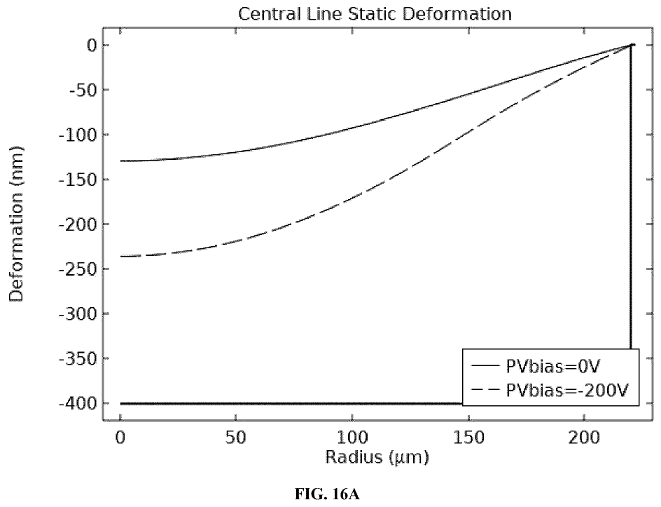

In FIG. 15A and FIG. 15B, the sending and receiving sensitivities of the conventional CMUT and the conventional PMUT with the same operating frequency of 1.0 MHz are compared respectively, and it can be seen that the performance of the CMUT is significantly better than that of the PMUT.

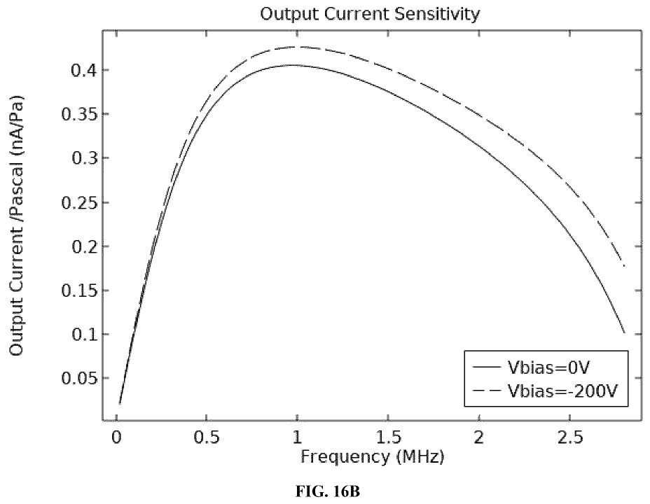

FIGS. 16A-16B show the integrated MUT with the above parameters, which can serve as the bias of the resonant plate at the piezoelectricity, implemented as follows:

By applying a negative direct-current piezoelectric bias voltage (PVbias) to the piezoelectric layer, the limitations of the pull-in effect are broken to significantly reduce the air gap of the CMUT and improve the receiving sensitivity of the CMUT. The specific electrode configuration method may refer to FIG. 5B. FIG. 16A and FIG. 16B respectively show the deformation change of the resonant plate and the output current change after applying different negative direct-current piezoelectric bias voltages (PVbias=0 V and PVbias=−200 V).

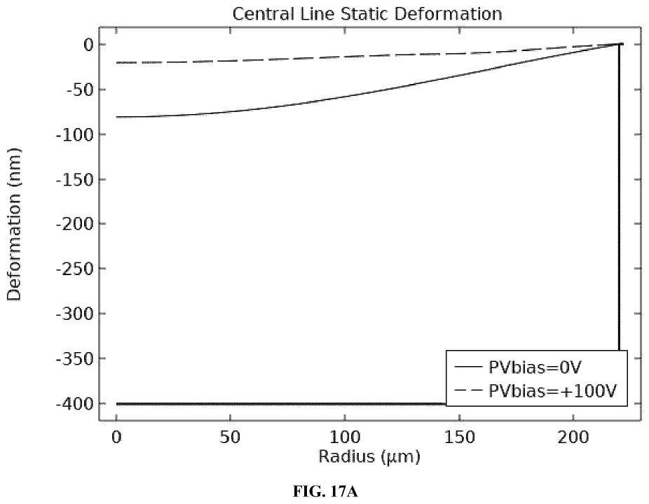

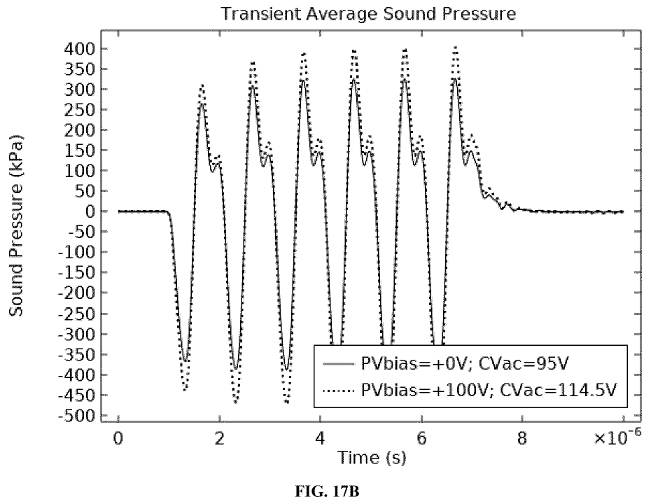

FIGS. 17A-17B show the implementation of a piezoelectric biased resonant plate. By applying the positive direct-current piezoelectric bias voltage (PVbias), the air gap of the CMUT is prominently increased, and the output sound pressure of the CMUT is increased. The specific electrode configuration method may refer to FIG. 5D. FIG. 17A and FIG. 17B respectively show the deformation change of the resonant plate and the output sound pressure change after applying different positive direct-current piezoelectric bias voltages (PVbias=0 V and PVbias=100 V).

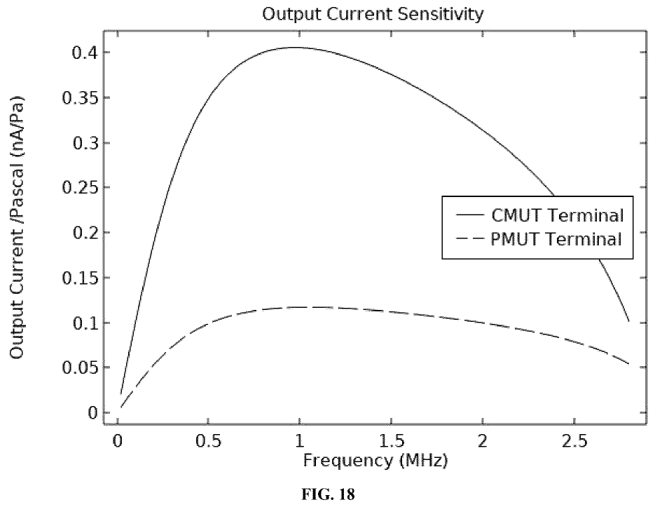

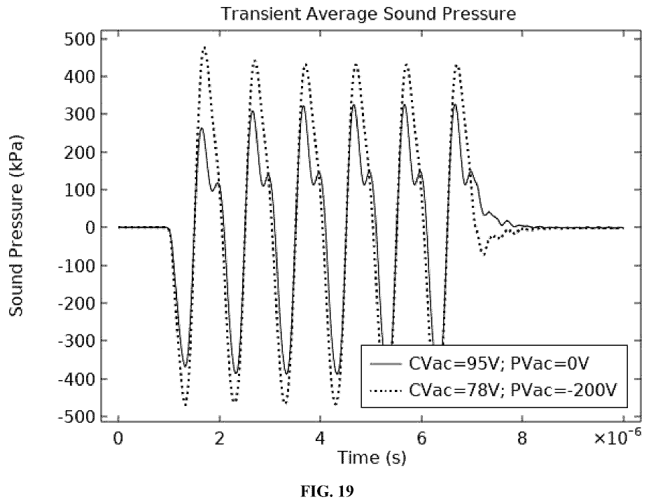

FIG. 18 shows that in an application scenario in which the piezoelectricity and the static electricity serve as dual receptions, the sensitivities of the capacitive MUT body and the piezoelectric MUT in the integrated MUT are respectively shown by the solid line and the dotted line in FIG. 18, and the receiving sensitivities of the two can be accumulated, thereby improving the overall receiving sensitivity of the integrated MUT. The specific electrode configuration method may refer to FIG. 5A.

FIG. 19 shows that the integrated MUT in the embodiments of the present disclosure serve as dual receptions to reduce the driving voltage and increase the output sound pressure. CVac in FIG. 19 represents the electrostatic driving signal connected to the pair of electrostatic lead electrodes corresponding to the chamber in the capacitive MUT body. PVac in FIG. 19 represents the piezoelectric driving signal connected to the pair of piezoelectric lead electrodes of the piezoelectric structure. The solid line in FIG. 19 is the curve of the output sound pressure when CVac=95 V and PVac=0 V (i.e., when the capacitive MUT body performs single sending). The dotted line in FIG. 19 is the curve of the output sound pressure when CVac=78 V and PVac=−200 V (i.e., dual sending). It can be seen from FIG. 19 that dual sending increases the output sound pressure and reduces the electrostatic driving signal (from 95V to 78V) compared to single sending, i.e., reducing the driving voltage.

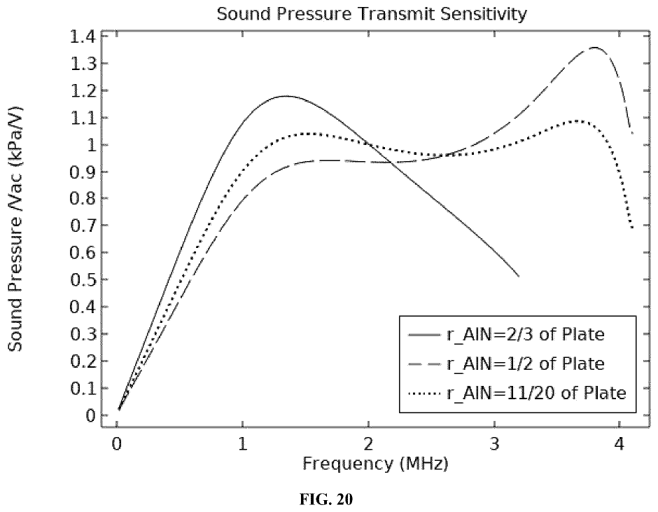

The size of the piezoelectric layer is optimized, such that multiple modes of the resonant plate can be integrated, and the bandwidth of the transducer is remarkably widened, as shown in FIG. 20. In addition, the shape, position and polarization direction of the piezoelectric layer are different, resulting in the integration of modes.

Based on the above embodiments, the technical solutions of the present disclosure have the following beneficial effects:

The receiving sensitivity and the maximum output sound pressure are the conflicting core performance indicators of the existing single-plate single-chamber CMUT design. The significant advantage of the proposed CMUT and PMUT integrated design is to achieve the maximum sensitivity while increasing the maximum output sound pressure and also taking into account reducing the driving voltage and increasing the bandwidth.
(1) High receiving sensitivity;
(2) Prominently increased receiving bandwidth;
(3) Increased output sound pressure;
(4) Low driving voltage;
(5) The piezoelectricity or the static electricity may both serve as a detection means to feed back the resonance amplitude or position information of the resonant plate, thereby achieving closed-loop resonance control;
(6) A multi-electrode configuration enables the piezoelectricity or the static electricity to operate independently or in combination, and at a low driving voltage, the maximum output sound pressure and the optimal receiving sensitivity are obtained;
(7) Gas squeeze-film damping can be introduced to further adjust the bandwidth and dynamic characteristics;
(8) Piezoelectric actuation or sensing can also be applied to an MUT with multiple chambers to achieve physical separation of sending and receiving chambers, thereby maximizing the output sound pressure, optimizing the receiving sensitivity and bandwidth, and minimizing the driving voltage.

Each embodiment in the description is described in a progressive mode, each embodiment focuses on differences from other embodiments, and references can be made to each other for the same and similar parts between embodiments.

Specific examples are used herein for illustration of the principles and embodiments of the present disclosure. The description of the foregoing embodiments is used to help understand the method of the present disclosure and the core principles thereof. In addition, those of ordinary skill in the art can make various modifications in terms of specific embodiments and scope of application in accordance with the teachings of the present disclosure. In conclusion, the content of the description shall not be construed as limitations to the present disclosure.

What is claimed is:

1. An integrated micro-electromechanical systems (MEMS) ultrasonic transducer (UT), wherein the integrated MEMS UT (MUT) comprises a capacitive MUT body, and a piezoelectric structure provided on a resonant plate of the capacitive MUT body.

2. The integrated MUT according to claim 1, wherein the piezoelectric structure comprises a piezoelectric layer and an electrode layer.

3. The integrated MUT according to claim 1, wherein there is one or more piezoelectric structures; and
when there are a plurality of piezoelectric structures, the plurality of piezoelectric structures are distributed at different positions, and/or, the plurality of piezoelectric structures are in different polarization directions and capable of being integrated to adjust a vibration mode of the resonant plate.

4. The integrated MUT according to claim 1, wherein the capacitive MUT body is a single-chamber capacitive MUT or a multi-chamber capacitive MUT.

5. The integrated MUT according to claim 4, wherein the single-chamber capacitive MUT comprises a substrate, a chamber provided on the substrate, a resonant plate provided at a top of the chamber, and an insulating layer provided between the resonant plate and the chamber.

6. The integrated MUT according to claim 4, wherein the multi-chamber capacitive MUT comprises a substrate, a plurality of chambers provided on the substrate, and an insulating layer provided between a resonant plate and the chamber, wherein the resonant plate is at least disposed at a top of each chamber, upper and lower adjacent chambers share a resonant plate, at least two of the plurality of chambers have different heights in a natural state, and/or, at least one of the resonant plates shared by the upper and lower adjacent chambers is capable of deforming.

7. The integrated MUT according to claim 5, wherein at least one surface of at least one resonant plate is a conformal surface, and/or, an electrode provided on an upper surface of the substrate has a conformal surface, and/or, at least a part of the upper surface of the substrate is a conformal surface.

8. The integrated MUT according to claim 7, wherein the conformal surface comprises a three-dimensional curved surface, multiple steps, a slope, or a combined structure, and the combined structure is a combination of at least one of the three-dimensional curved surface, the multiple steps, and the slope.

9. The integrated MUT according to claim 5, wherein the substrate is provided with one or more through vias and/or a plate hollow, and/or, a part of the substrate located in the chamber is provided with a microfluidic channel.

10. The integrated MUT according to claim 5, wherein each chamber corresponds to a pair of electrostatic lead electrodes, and every two adjacent chambers share a same electrostatic lead electrode; and
the piezoelectric structure corresponds to a pair of piezoelectric lead electrodes.

11. The integrated MUT according to claim 10, wherein
the integrated MUT comprises at least one of a normal operating mode and a collapse operating mode, wherein the normal operating mode and the collapse operating mode both comprise a single-receiving sub-mode, a single-sending sub-mode, a dual-receiving sub-mode, a dual-sending sub-mode, and a cooperative assistance sub-mode.

12. The integrated MUT according to claim 11, wherein
there is one or more piezoelectric structures,
wherein when there are a plurality of piezoelectric structures, all or some of the piezoelectric structures cooperate with the capacitive MUT body to enable the integrated MUT to operate in the dual-sending sub-mode, the dual-receiving sub-mode, or the cooperative assistance sub-mode of the normal operating mode or the collapse operating mode.

13. The integrated MUT according to claim 12, wherein
when there are a plurality of piezoelectric structures, some of the piezoelectric structures cooperate with the capacitive MUT body and operate in the cooperative assistance sub-mode of the normal operating mode or the collapse operating mode, and the remaining piezoelectric structures are configured to send or receive signals.

14. The integrated MUT according to claim 11, wherein
when the capacitive MUT body is a single-chamber capacitive MUT:
in the dual-receiving mode, the pair of electrostatic lead electrodes corresponding to the chamber in the capacitive MUT body is connected to a direct-current electrostatic bias voltage, and the chamber in the capacitive MUT body and/or the piezoelectric structure are configured to receive signals;
in the dual-sending mode, the pair of piezoelectric lead electrodes of the piezoelectric structure is connected to a piezoelectric driving signal, and the pair of electrostatic lead electrodes corresponding to the chamber in the capacitive MUT body is connected to an electrostatic driving signal; and
in the cooperative assistance mode, when a signal is received, the pair of piezoelectric lead electrodes of the piezoelectric structure is connected to a first direct-current piezoelectric bias voltage such that a height of the chamber in the capacitive MUT body decreases, and the chamber in the capacitive MUT body is configured to receive a signal; and when a signal is sent, the pair of piezoelectric lead electrodes of the piezoelectric structure is connected to a second direct-current piezoelectric bias voltage such that the height of the chamber in the capacitive MUT body increases, and the pair of electrostatic lead electrodes corresponding to the chamber in the capacitive MUT body is connected to an electrostatic driving signal.

15. The integrated MUT according to claim 11, wherein when the capacitive MUT body is a multi-chamber capacitive MUT:
in the dual-receiving mode, a receiving chamber in the capacitive MUT body and the piezoelectric structure are both configured to receive signals, and the receiving chamber is one or more chambers in the capacitive MUT body;
in the dual-sending mode, a sending chamber in the capacitive MUT body and the piezoelectric structure are both configured to send signals, and the sending chamber is one or more chambers in the capacitive MUT body; and
in the cooperative assistance mode, the piezoelectric structure is configured to change a height of a main chamber in the capacitive MUT body, the main chamber is configured to send or receive a signal, and the main chamber is one or more chambers adjacent to the piezoelectric structure in the capacitive MUT body.

16. The integrated MUT according to claim 11, wherein
in a collapse mode, the chamber in the capacitive MUT body is in a collapse state,
wherein
the pair of piezoelectric lead electrodes of the piezoelectric structure is connected to a direct-current piezoelectric bias voltage, such that the chamber in the capacitive MUT body is in the collapse state, and
when the chamber in the collapse state serves as a receiving chamber, the pair of electrostatic lead electrodes corresponding to the chamber in the collapse state is connected to a direct-current electrostatic bias voltage, and the chamber in the collapse state is configured to receive a signal; and
when the chamber in the collapse state serves as a sending chamber, the pair of electrostatic lead electrodes corresponding to the chamber in the collapse state is connected to an electrostatic driving voltage, and the electrostatic driving signal is an alternating-current driving signal, or a signal obtained after the alternating-current driving signal is subjected to direct-current bias, or a continuous pulse signal, or a signal obtained after the continuous pulse signal is subjected to direct-current bias.

17. The integrated MUT according to claim 11, wherein
in a collapse mode, the chamber in the capacitive MUT body is in a collapse state,
wherein
the pair of electrostatic lead electrodes corresponding to the chamber in the capacitive MUT body is connected to a direct-current electrostatic bias voltage, such that the chamber in the capacitive MUT body is in the collapse state, and
when the chamber in the collapse state serves as a receiving chamber, the chamber in the collapse state is configured to receive a signal, and/or, the piezoelectric structure is configured to receive a signal; and
when the chamber in the collapse state serves as a sending chamber, the pair of piezoelectric lead electrodes of the piezoelectric structure is connected to a piezoelectric driving signal, and/or, the pair of electrostatic lead electrodes corresponding to the chamber in the collapse state is connected to an electrostatic driving signal.

18. The integrated MUT according to claim 6, wherein at least one surface of at least one resonant plate is a conformal surface, and/or, an electrode provided on an upper surface of the substrate has a conformal surface, and/or, at least a part of the upper surface of the substrate is a conformal surface.

19. The integrated MUT according to claim 6, wherein the substrate is provided with one or more through vias and/or a plate hollow, and/or, a part of the substrate located in the chamber is provided with a microfluidic channel.

20. The integrated MUT according to claim 6, wherein each chamber corresponds to a pair of electrostatic lead electrodes, and every two adjacent chambers share a same electrostatic lead electrode; and
the piezoelectric structure corresponds to a pair of piezoelectric lead electrodes.
